(19) United States
(12) Patent Application Publication
(10) Pub. No.: US 2026/0178323 A1
(43) Pub. Date: Jun. 25, 2026

(54) APPARATUS AND METHOD FOR GENERATING PRODUCT REQUIREMENTS DOCUMENTS USING LARGE LANGUAGE MODELS

(71) Applicant: Crowdbotics Corporation, Berkeley, CA (US)

(72) Inventors: Anand KULKARNI, Berkeley, CA (US); Charathram RANGANATHAN, Berkeley, CA (US); Santosh PURBEY, Berkeley, CA (US); Abdelhak REFFAS, Berkeley, CA (US); Eduardo Felipe WEBER, Berkeley, CA (US); Cory HYMEL, Berkeley, CA (US)

(21) Appl. No.: 19/422,215

(22) Filed: Dec. 16, 2025

Related U.S. Application Data
(60) Provisional application No. 63/736,511, filed on Dec. 19, 2024.

(51) Int. Cl. G06F 8/73; G06F 8/10

(52) U.S. Cl. CPC G06F 8/73; G06F 8/10

(57) ABSTRACT

A machine has a network interface circuit with connectivity to a network interconnecting a client machine and a large language model machine. A bus connects the network interface circuit, a processor and a memory. The memory stores instructions executed by the processor to receive a natural language product requirements description from the client machine, generate an exemplary list of features for the natural language product requirements description, and produce a specification of expected output. The natural language product requirements description, the exemplary list of features and the expected output are passed to the large language model machine. A response from the large language model machine is evaluated for product requirements completeness and accuracy.

### CROSS REFERENCE TO RELATED APPLICATION

This application claims priority to U.S. Provisional Patent Application 63/736,511, filed Dec. 19, 2024, the contents of which are incorporated herein by reference.

### FIELD OF THE INVENTION

The present invention relates generally to automated software documentation systems, and more particularly to systems and methods for generating product requirements documents using natural language processing and large language models.

### BACKGROUND OF THE INVENTION

In the software development industry, creating detailed and accurate product requirements documents (PRDs) and specifications is a critical task that lays the foundation for successful project execution. Traditional methods for generating PRDs are often manual, time-consuming, and prone to human error, leading to inefficiencies and project delays. Recently, advancements in large language models (LLMs) have spurred interest in automating various aspects of software development, including requirements gathering and documentation. However, existing solutions are typically limited in scope, specific to certain LLMs, and lack the flexibility needed to adapt to diverse project requirements and varying LLM technologies. There is a need for a system capable of generating PRDs from natural language input in a flexible, scalable, and efficient manner, while remaining agnostic to the underlying LLM technology.

### SUMMARY

A machine has a network interface circuit with connectivity to a network interconnecting a client machine and a large language model machine. A bus connects the network interface circuit, a processor and a memory. The memory stores instructions executed by the processor to receive a natural language product requirements description from the client machine, generate an exemplary list of features for the natural language product requirements description, and produce a specification of expected output. The natural language product requirements description, the exemplary list of features and the expected output are passed to the large language model machine. A response from the large language model machine is evaluated for product requirements completeness and accuracy.

### BRIEF DESCRIPTION OF THE DRAWINGS

The invention is more fully appreciated in connection with the following detailed description taken in conjunction with the accompanying drawings, in which:

FIG. 1 is an overview of the operation of an embodiment of the invention.

FIG. 2 illustrates processing modules to implement an embodiment of the invention.

FIG. 3 illustrates operations performed by the disclosed input module.

FIG. 4 illustrates operations performed by the disclosed decomposition module.

FIG. 5 illustrates operations performed by the disclosed decomposition module.

FIG. 6 illustrates a system configured in accordance with an embodiment of the invention.

Like reference numerals refer to corresponding parts throughout the several views of the drawings.

### DETAILED DESCRIPTION

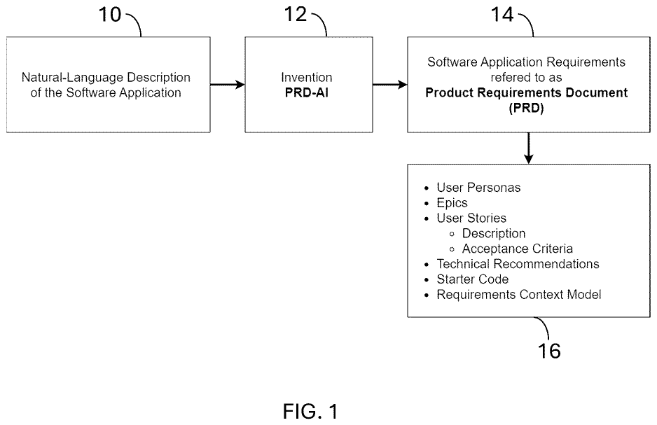

FIG. 1 is an overview of the operation of an embodiment of the invention. A natural language description of a software application 10 is applied to a Product Requirements Document (PRD) Artificial Intelligence (AI) agent 12, which produces a software application requirements document 14. User personas, epics, user stories, technical recommendations starter code and requirements context 16 may then be derived from the PRD 14, as discussed below.

PRD-AI agent 12 is an innovative system designed to generate PRDs from natural language input using LLMs. The system leverages advanced techniques, including prompt engineering, prompt injection, retrieval-augmented generation, and semantic search, to produce robust PRDs that can be tailored for various applications within the software development lifecycle.

The modular architecture of PRD-AI allows for seamless integration with different LLMs, making it adaptable to the evolving landscape of AI technology. One of the invention's key innovations is its method of “progressive decomposition,” which recursively breaks down requirements into smaller, manageable tasks and associates functional tests with each feature. These tasks are clearly defined and suitable for AI-based code generation.

Additionally, PRD-AI includes a comprehensive evaluation mechanism powered by Generative AI, which generates independent quantitative measures of the PRD's completeness and accuracy.

This functionality enhances the system's utility across various software development activities, including but not limited to project scoping, requirements engineering, generating software quotes, and creating project plans.

The invention is disclosed in connection with the following terminology.
Generative AI-Based Evaluation: An independent assessment process within PRD-AI that uses AI to evaluate the completeness, accuracy, and alignment of the generated PRD with the initial input requirements.
Large Language Model (LLM): A type of artificial intelligence model designed to process and generate human-like text. LLMs are used in PRD-AI to interpret natural language input and generate structured output for product requirements.
LLM-Agnostic: The ability of the system to integrate with any large language model (LLM) without dependency on a specific model, ensuring flexibility and compatibility as new LLMs are developed.
Parallel Processing: A method that enables the system to handle multiple LLM requests concurrently, optimizing performance and reducing processing time for complex PRDs.
Progressive Decomposition: A recursive method employed by PRD-AI to break down high-level requirements into smaller, actionable tasks. This process enables detailed planning and facilitates the generation of tasks that are suitable for automated code generation.
Prompt Engineering: The process of designing and structuring prompts to guide the LLM in interpreting user input correctly. In PRD-AI, prompt engineering ensures that the LLM accurately understands the context of user requirements and produces relevant output.
Prompt Injection: A technique that injects specific instructions or constraints within prompts sent to the LLM, guiding it to generate output that aligns closely with the user's requirements.
Retrieval-Augmented Generation: A technique that combines LLM-generated responses with information retrieved from external sources or knowledge bases. This enhances the LLM's output by incorporating contextually relevant data, ensuring that PRDs are accurate and comprehensive.
Semantic Search: A search technique that uses meaning-based algorithms to retrieve relevant information, enhancing PRD generation by integrating contextually related data from previous outputs or knowledge bases.
Task Generation: The process by which high-level requirements are transformed into discrete, actionable tasks. These tasks are clearly defined and formatted to be suitable for automated code generation tools.

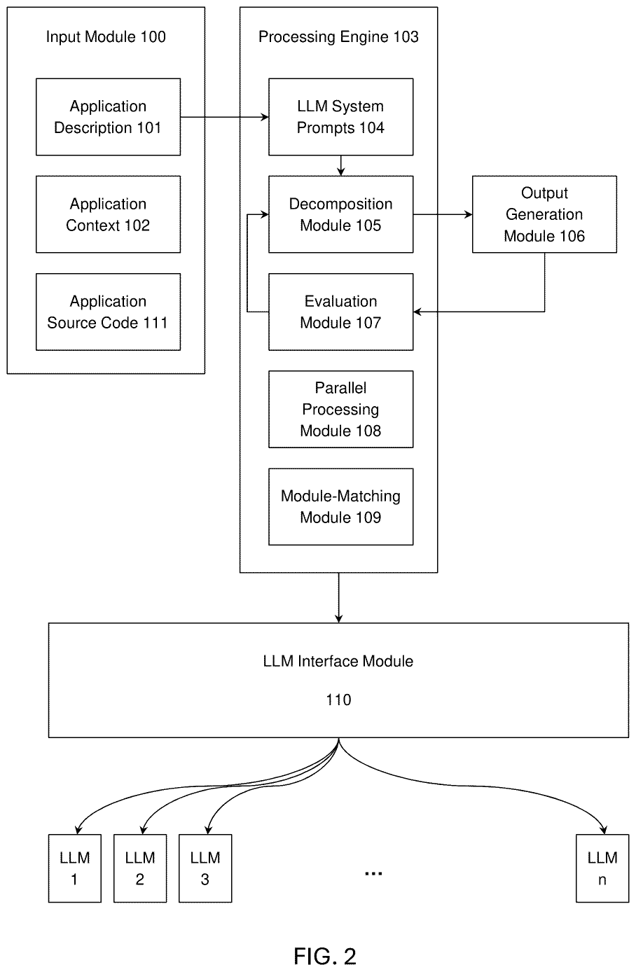

FIG. 2 illustrates processing modules to implement an embodiment of the invention. An input module 100 receives an application description 101, an application context 102 and optionally application source code 111. A processing engine 103 generates LLM system prompts 104. A decomposition module 105 is in a closed loop with an output generation module 106 and an evaluation module 107. A parallel processing module 108 generates tasks that the module matching module 109 distributes to an LLM interface module 110 to perform the tasks in parallel across LLM 1, LLM 2, LLM 3 and LLM N.

As previously indicated, the Input Module 100 passes an application description 101 and application context 102 to the processing engine 103. During processing, the system provides system prompts 104 to guide the LLM in interpreting user requests and generating a high-level breakdown of application features. These prompts serve as guidelines for the LLM to specialize in transforming natural language into software requirements.

Next, the decomposition module 105, aided by the LLM interface module 110, further refines the requirements through progressive decomposition into smaller tasks. Upon completing decomposition, the output generation module 106 formats the initial output. The PRD is then evaluated by the evaluation module 107 in iterative cycles until it meets the quality threshold. When complete, the formatted PRD is presented to the user.

Table 1 more fully characterizes the components of FIG. 2.

TABLE 1

| Item | Component | Description |
|---|---|---|
| 100 | Input Module | Accepts natural language input, typically in |
| | | the form of textual descriptions of desired |
| | | software functionality or features. |
| 101, 102 | Application | Provides contextual information for |
| | Description | processing. |
| | and Context | |
| 103 | Processing | Utilizes techniques such as prompt |
| | Engine | engineering, prompt injection, and retrieval- |
| | | augmented generation to process the input |
| | | and generate initial PRDs. |
| 104 | LLM System | Defines prompts specific to the LLM |
| | Prompts | processing requirements. |
| 105 | Decomposition | Implements the method of “progressive |
| | Module | decomposition,” recursively breaking down |
| | | high-level requirements into smaller tasks. |
| | | These tasks are fine-grained, clearly defined, |
| | | and can be used for code generation. |
| 106 | Output | Compiles and formats the final PRDs |
| | Generation | or other artifacts. |
| | Module | |
| 107 | Evaluation | Generates an independent LLM-driven |
| | Module | evaluation of the PRD. This module provides |
| | | quantitative measures of the PRD's |
| | | completeness, accuracy, coherence, and |
| | | alignment with the initial input requirements. |
| 108 | Parallel | Processes each top-level feature of a PRD |
| | Processing | independently through parallel LLM jobs. |
| | Module | Each job receives a unique prompt with |
| | | contextual details to ensure cohesion across |
| | | all parallelized tasks. This process generates |
| | | an expanded feature definition. |
| 109 | Module- | Matched pre-existing, containerized code to |
| | Matching | a given feature description within a PRD. |
| | Module | |
| 110 | LLM Interface | Manages interactions with various large |
| | Module | language models. This module is designed |
| | | to be LLM-agnostic, allowing for easy |
| | | integration of different LLMs as needed. |

The input module 100 serves as the entry point for user-submitted requirements in the form of text data or image data and prepares them for processing by the PRD-AI system 12. In one embodiment, the input module comprises three sub-modules, namely application description 101, application context 102, both of which gather user inputs and consolidate them into a format suitable for the processing engine, as well as the application source code 111, which enables the system to process source code of an application as input to generating a PRD.

The input module also filters the user input via a content filtering system. It uses an ensemble of multi-class classification models to detect four categories of harmful content (violence, hate, sexual, and self-harm) at four severity levels respectively (safe, low, medium, and high).

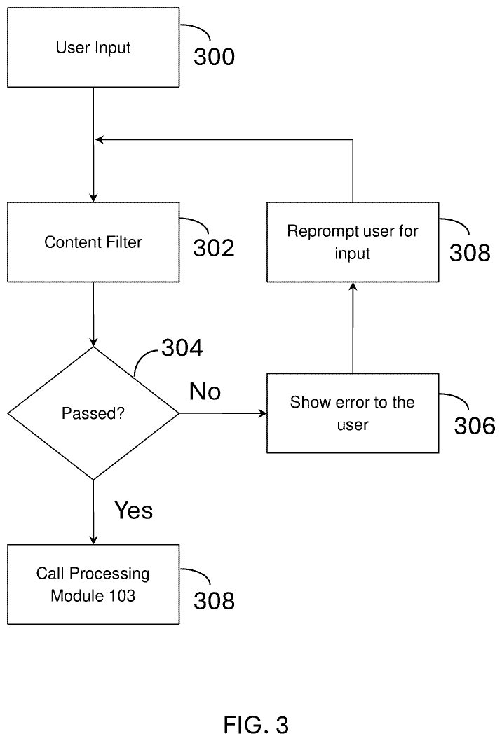

FIG. 3 illustrates input module processing. User input 300 is received and is applied against the content filter 302. If the input does not pass harm measures (304—No), errors are shown to the user 306 and the user is prompted for different input 308. This cycle repeats until content filter measures are passed (304—Yes), at which point the content is applied to the processing module 308.

Consider the following example. The user might input descriptions such as “The platform should allow users to upload and share recipes, rate recipes from other users, and participate in discussions via comments.” The Input Module captures this natural language input, setting the stage for further processing.

The application description 101 and context 102 use user input and inject them into the LLM System Prompt 104 to provide contextual information that aids in understanding the user's input, including background details or additional specifications that define the application environment.

Building on this example, which will be referred to as Culinary Canvas, context might include specifying that the platform aims to build a community of food enthusiasts. This context helps the system interpret features like “comments” or “rating” within a community-driven setting.

The processing engine 103 utilizes advanced techniques such as prompt engineering, prompt injection, and retrieval-augmented generation. These techniques guide the LLM to process user input and generate an initial PRD structure based on specified requirements.

The processing engine 103 is composed of the following sub-modules:
1. LLM System Prompts 104
2. Decomposition Module 105
3. Output Generation Module 106
4. Evaluation Module 107
5. Parallel Processing Module 108
6. Module-Matching Module 109

For Culinary Canvas, the processing engine 103 might begin with prompts instructing the LLM to list core features, such as “recipe sharing,” “rating system,” and “discussion threads.” This step generates the foundational structure of the PRD.

The LLM system prompts 104 are predefined prompt instructions that give the LLM context and guide it to understand user requirements as software functionality, ensuring accurate interpretation of user intent.

For the Culinary Canvas example, system prompts could guide the LLM with phrases like “Generate user stories for a recipe upload feature that allows users to add, tag, and share recipes.” These prompts ensure the LLM generates output that aligns closely with community-driven recipe sharing.

The system uses a series of system prompts instructing the LLM to respond as an expert in creating software requirements. These system prompts are used in different combinations based on what functionality is needed by the larger system. In one embodiment, all system prompts are sent to the underlying LLM model in JSON format.

The following provides examples of system prompt categories and features.

```
Format:
  {
    ”Category”:

[symbol]

Example:
  {
      ″Onboarding″: [″Sign-up with Email or Phone number″, ″Sign-up
with Facebook″, ″Account setup wizard″, ″Profile customization″,
″Connecting with contacts″ [symbol] ″Privacy settings introduction″ [symbol]
    The following is an example of a system prompt for user personas.
Format:
  {
      ”Example App Name” : [ User

[symbol]

Example:
  {
      ″Instagram″: [″Ordinary Users″, ″Business

[symbol]

[symbol]

indicates data missing or illegible when filed
```

The following is a system prompt feature description used to generate a full set of data associated with a given user story.

```
Format:
  {
    ”Feature Name” : [”xxx”, ...],
    ”Feature Category” : [”Category Name 1”, ...],
    ”User roles” : [ ”User Role 1” , ...],
    ”Description” : [”Description of the

[symbol]

Example:
  {
    ″Feature name″: [″Search bar for movies and users″],
    ″Feature category″: [″Search & Discover″],
    ″User roles″: [″Main Users″],
    ″Description″: [″The ′Search bar for movies and users′
feature in ′My Moovies′ app provides a versatile search
functionality, enabling users to quickly find movies or other
users within the app. It offers an intuitive interface for
entering search queries. The search results are efficiently

[symbol]

[symbol]

indicates data missing or illegible when filed
```

The decomposition module 105 implements a process called progressive decomposition, breaking down high-level requirements into smaller, actionable tasks suitable for precise software development planning. This process ensures each feature is decomposed to an atomic level, ready for further development or potential AI-based code generation. In one embodiment, the decomposition module 105 generates a detailed, structured hierarchy of requirements, including:
User Personas
Epics
User Stories
Descriptions
Acceptance Criteria
Technical Recommendations
Starter Code

For the Culinary Canvas example, the decomposition module 105 might break down a feature such as “discussion threads” into tasks such as “add comments to a recipe,” “reply to existing comments,” and “rate comments.”

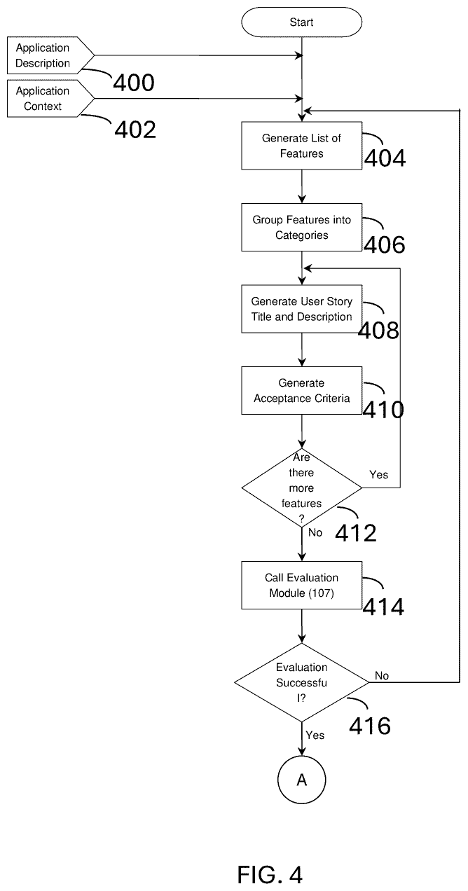

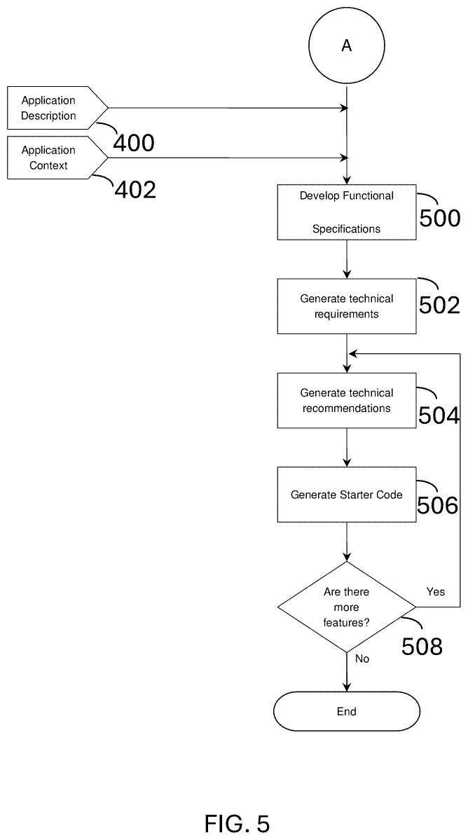

FIG. 4 illustrates operations performed by the decomposition module 105. An application description 402 and application context 402 are received from the user, which results in the decomposition module 104 generating a list of features 404. The features are grouped into categories 406, which allows the module to generate a user story title and description. The module 105 then generates acceptance criteria 410. If there are more features (412—Yes), control returns to block 404. If there are no more features (412—No), the evaluation module is called 414. If the evaluation is not successful (416—No), control returns to block 404. If the evaluation is successful (416—Yes) control proceeds to element A, which results in the processing of FIG. 5.

To generate the list of features, the LLM is prompted to act as a software product manager who is creating the list of features for the application. A combination of the LLM's own training data and a set of multi-shot examples are used to direct the LLM to generate a complete set of features. In one embodiment, the list of features is sent to an LLM-as-a-judge subsystem which uses a different LLM to critique the list of features for accuracy and completeness.

The LLM prompt to generate the list of features is structured as follows:
1. LLM's role, for example, “You are the project manager tasked with the development of a new application. Your first and foremost responsibility is to analyze the provided application description and distill it into a comprehensive list of features that will guide the development team.”
2. Key actions to be taken by the LLM when generating the list of features:
   a. Understand the application's purpose.
   b. Identify key functionalities.
   c. Organize features into categories.
3. Multi-shot examples to guide the LLM. These take the following format:
   a. Application description.
   b. Sample feature list generated for that application.

The output from the LLM is a JSON object that contains a list of features, grouped into categories. For example, the output might look as follows:

```
{{
  “Onboarding & User Management”: [
    “Sign-up with Email”,
    “Sign-up with Google”,
    “Account setup wizard”,
    “Profile customization”,
    “Connecting with team members”,
    “Privacy settings introduction”,
    “Team member profiles and role assignment”,
    “Permissions management”,
    “External user collaboration capabilities”,
    “Invite team members feature”,
    “Two-factor authentication for enhanced security”,
    “Bulk user import from CSV or Excel for easy team setup”,
    “Customizable onboarding checklists for new users”,
    “Integration with LDAP/Active Directory for user management”,
    “User activity and audit logs for compliance and monitoring”
  ],
  “Dashboard & Project Overview”: [
    “Personalized dashboards”,
    “View critical projects and tasks”,
    “Deadline tracking”,
    “Priority and dependency indicators”,
    “Critical project and task views”,
    “Customizable widget-based dashboards for personalized data visualization”,
    “Integration with calendar apps for deadline and event synchronization”,
    “AI-driven insights for project health and risk assessment”,
    “Real-time project budget tracking and alerts”
  ],
  “Task Management”: [
    “Task creation and assignment”,
    “Real-time task status updates”,
    “Commenting on tasks”,
    “File attachments for tasks”,
    “Deadline, priority, and dependency settings”,
    “Task tracking”,
    “Customizable task labels”,
    “Voice command integration for task creation and updates”,
    “Machine learning-based task priority and deadline suggestions”,
    “Integration with email clients for direct task creation from emails”,
    “Task delegation and auto-rescheduling based on team availability”
  ],
  “Project Planning Tools”: [
    “Kanban boards for agile workflows”,
    “Gantt charts for timeline planning”,
    “Visual project timelines”,
    “Project dependencies visualization”,
    “Agile workflow support”,
    “Interactive mind maps for brainstorming and project planning”,
    “Risk management modules to identify and mitigate project risks”,
    “Capacity planning tools for resource allocation optimization”
  ],
  “Communication & Collaboration”: [
    “Integrated chat system”,
    “Discussion forums”,
    “Real-time notifications”,
    “External stakeholder communication”,
    “Email notifications”,
    “Centralized document repository”,
    “Video conferencing integration for remote team meetings”,
    “Live document editing with real-time collaboration”,
    “Mentions and hashtags for better organization in discussions”
  ],
  “Document Management & Storage”: [
    “Centralized repository for documents”,
    “File storage and sharing”,
    “Collaboration on documents”,
    “Version control”,
    “OCR capabilities for searchable documents from images”,
    “Automated document categorization and tagging for easy retrieval”,
    “Secure document sharing with external users via expiring links”
  ],
  “Time Tracking & Reporting”: [
    “Task and project time tracking”,
    “Customizable performance reports”,
    “Workload management”,
    “Resource planning analytics”,
    “Performance analysis”,
    “Integration with financial software for invoicing based on tracked time”,
    “Predictive time tracking for future task estimation”,
    “Customizable dashboard for individual performance metrics and KPIs”
  ],
  “Integrations & Workflow Automation”: [
    “Google Workspace integration”,
    “Slack integration”,
    “GitHub integration”,
    “Dropbox integration”,
    “API for custom integrations”,
    “Automated task assignments”,
    “Notification automation”,
    “Support for Agile, Scrum, and Waterfall methodologies”,
    “Custom workflow creation”,
    “Integration with CRM systems for seamless customer data access”,
    “Pre-built templates for common workflow automations”,
    “Machine learning-based suggestions for workflow improvements”
  ],
  “Customization & Security”: [
    “Customizable dashboards and reports”,
    “Customizable project templates”,
    “Role-based access control”,
    “Data encryption”,
    “Privacy settings and compliance”,
    “Customizable notifications”,
    “Project template customization”,
    “Task label customization”,
    “Personalized AI assistant for project management guidance”,
    “Blockchain-based data security for sensitive project information”,
    “Dynamic role-based access control with context-aware permissions”
  ],
  “Support & Compliance”: [
    “24/7 support and training resources”,
    “Compliance with industry standards”,
    “Guided setup and onboarding”,
    “Feedback collection and feature updates”,
    “AI-driven support chatbot for instant help and guidance”,
    “Regulatory compliance tracking for projects in sensitive industries”,
    “Real-time compliance reporting and notifications”
  ]
}}
```

Once a list of features is generated, the workflow uses another LLM prompt (408 and 410) to generate individual user stories (also called “Feature Descriptions”) and acceptance criteria for each feature. This is accomplished via a prompt that provides the LLM with the following:
1. The application description.
2. A list of feature categories and features (the output of 404 and 406).
3. An example of the output that is expected from the LLM in the form of a multi-shot example.

The output of 410 is a detailed description and acceptance criteria for each feature in the feature list (404). A sample of the output would look like the following (for just one acceptance criterion):

```
{{
  “feature_name”: “Search bar for movies and users”,
  “feature_category”: “Search & Discover”,
  “user_roles”: [“Main Users”],
  “description”: “The ‘Search bar for movies and users’ feature in ‘My Moovies’ app provides a versatile
search functionality, enabling users to quickly find movies or other users within the application. It
offers an intuitive interface for entering search queries. The search results are efficiently organized to
display relevant movies and user profiles based on the entered keywords. This feature is essential for
enhancing user experience by facilitating easy discovery and interaction within the application.”,
  “acceptance_criteria”: [
    “The search bar must be easily accessible and visible on the main screen of the application,
preferably at the top or in a floating action button.”,
    “Users must be able to input text into the search bar, with support for both movie titles and
usernames.”,
    “The app should implement an auto-complete feature using the TMDb (The Movie Database)
API to provide real-time suggestions and predictions as users type their queries, enhancing the user
experience.”,
    “Search results must be categorically divided into two distinct tabs or sections: one dedicated to
movies and the other to user profiles, ensuring organized and focused search outcomes.”,
    “For movie searches, the app should display results including movie titles, release years, and
thumbnails, utilizing the TMDb API. For user searches, results should include user names and profile
pictures.”,
    “Search results must include a default sorting by relevance. Additional filtering options, such as
genre, release year, popularity for movies, and follower count or recent activity for users, should be
available.”,
    “In cases where no results are found, the app should display a friendly message suggesting
alternate keywords or popular searches, avoiding user frustration.”,
    “From the search results, users must be able to tap on a movie or user profile to navigate to their
detailed view, which includes comprehensive information and user interaction options.”,
    “The search functionality must demonstrate high performance and quick response times,
effectively handling large datasets without significant delays. Performance metrics like response time
should be monitored regularly.”,
    “Include error handling to manage potential failures in network connectivity or issues with
third-party API responses, ensuring the app remains stable and provides feedback to the user about the
error.”,
    “The search algorithm should prioritize user privacy and data security, ensuring that sensitive
information is not exposed in the search results.”,
    “Integrate analytics to track and analyze user search patterns and behavior, which can be used to
further refine and improve the search algorithm and suggestions provided.”,
    “Ensure the search feature is compatible with the latest version of the app and is tested across
different devices and operating systems for consistency.”,
    “The search interface should be accessible, adhering to WCAG (Web Content Accessibility
Guidelines) standards, ensuring usability for all users, including those with disabilities.”
  ]
}}
```

Decision block 412 implements a loop over all the features in the feature list 404, 406.

Once the initial generation of the features (404), categories (406), user story titles, descriptions, and acceptance criteria (408, 410) are complete, an evaluation module (414) implements an LLM-as-a-Judge (LaaJ) mechanism to determine if the output is complete.

Block 414 inputs a list of features (404, 406) into a prompt that asks an LLM to identify if there are more features that it can identify for the given application description and context. Control then passes to 404 for the loop to repeat.

Progressive Decomposition is when the application's features are further broken down into progressively smaller units of work. The output of FIG. 4 along with the application description 400 and application context 402 are used to develop a functional specification 500, as shown in FIG. 5.

The LLM is prompted to generate a functional specification by asking it to act in the role of a software architect and to decompose the features into a set of layers:
User interface
Data schemas
Back end

After the functional specifications are created, each functional specification is passed to the LLM via a prompt that generates a list of recommended technology for implementing the feature (504). This considers the application context, which includes information about the infrastructure environment in which the application will run (such as cloud providers, frameworks that are used, etc.) The LLM is also prompted to generate a self-evaluation of each technical recommendation that it creates, along with a detailed report of why it chose that specific technology for the implementation.

The output of 504 is a list of technical recommendations, i.e. technologies, APIs, frameworks, etc., that will be used to implement the application.

Once the technical recommendations are generated, control passes to another workflow, 506, which generates application source code for each of those features. The source code is generated in the languages and frameworks that are identified in the technical recommendations. This follows a series of steps:
1. The LLM is prompted to generate a file and directory structure that is considered “industry standard” for the framework in which the application is being written. A multi-shot example is provided to guide the LLM as to what is considered “industry standard” file structure. Below is an example:

Here is a folder structure we follow for Django:
1. We use Django Rest Framework.
2. We plan for versioning for apis up fornt and make folder for each version.
3. Break down the project into smaller manageable apps.
4. Write Services classes for containing the functional components there.
5. We write unit tests for each application.
6. Web_build folder is where we serve the frontend build from.
7. We use Docker.
8. We use Pipfile.

| backend | | | |
|---|---|---|---|
| ├ Dockerfile | | | |
| ├ Pipfile | | | |
| ├ Pipfile.lock | | | |
| ├ README.md | | | |
| ├ docker-compose.override.yml | | | |
| ├ docker-compose.yml | | | |
| ├ ent_demo_chatbot_he_44473 | | | |
| \| | ├ _{——}init_{——}.py | | |
| \| | ├ settings.py | | |
| \| | ├ urls.py | | |
| \| | ├ wsgi.py | | |
| ├ heroku.yml | | | |
| ├ home | | | |
| \| | ├ _{——}init_{——}.py | | |
| \| | ├ admin.py | | |
| \| | ├ api | | |
| \| | \| | ├ _{——}init_{——}.py | |
| \| | \| | └ v1 | |
| \| | \| | | ├ _{——}init_{——}.py |
| \| | \| | | ├ serializers.py |
| \| | \| | | ├ urls.py |
| \| | \| | | └ viewsets.py |
| \| | ├ apps.py | | |
| \| | ├ management | | |
| \| | \| | ├ _{——}init_{——}.py | |
| \| | \| | └ commands | |
| \| | \| | | ├ _{——}init_{——}.py |
| \| | \| | | ├ createsuperuserauto.py |
| \| | \| | | ├ customchangepassword.py |
| \| | \| | | ├ generate_project_report.py |
| \| | \| | | └ upgradetosuperuser.py |
| \| | ├ migrations | | |
| \| | \| | ├ 0001_load_initial_data.py | |
| \| | \| | └ _{——}init_{——}.py | |
| \| | ├ models.py | | |
| \| | ├ storage_backends.py | | |
| \| | ├ templates | | |
| \| | \| | ├ account | |
| \| | \| | \| | ├ login.html |
| \| | \| | \| | ├ logout.html |
| \| | \| | \| | └ signup.html |
| \| | \| | ├ base.html | |
| \| | \| | ├ home | |
| \| | \| | \| | └ index.html |

| | | |
|---|---|---|
| \| | \| | └ users |

| | | |
|---|---|---|
| \| | \| | ├ user_detail.html |
| \| | \| | └ user_form.html |

| \| | ├ tests.py | |
|---|---|---|
| \| | ├ urls.py | |
| \| | └ views.py | |
| ├ manage.py | | |
| ├ modules | | |
| \| | ├ _{——}init_{——}.py | |
| \| | ├ admin.py | |
| \| | ├ apps.py | |
| \| | ├ manifest.py | |
| \| | ├ migrations | |
| \| | \| | └ _{——}init_{——}.py |
| \| | ├ options.json | |
| \| | ├ urls.py | |
| \| | └ utils.py | |
| ├ static | | |
| \| | ├ css | |
| \| | \| | └ main.css |
| \| | └ img | |
| \| | | └ slack-app-pencil.png |
| ├ users | | |
| \| | ├ _{——}init_{——}.py | |
| \| | ├ adapters.py | |
| \| | ├ admin.py | |
| \| | ├ apps.py | |
| \| | ├ forms.py | |
| \| | ├ migrations | |
| \| | \| | ├ 0001_initial.py |
| \| | \| | └ _{——}init_{——}.py |
| \| | ├ models.py | |
| \| | ├ tests | |
| \| | \| | ├ _{——}init_{——}.py |
| \| | \| | ├ factories.py |
| \| | \| | ├ test_forms.py |
| \| | \| | ├ test_models.py |
| \| | \| | ├ test_urls.py |
| \| | \| | └ test_views.py |

| | |
|---|---|
| \| | ├ urls.py |
| \| | └ views.py |

└ web_build

├ index.html
└ static

Subsequently, the LLM is prompted to generate source code for each feature from FIG. 4 and the source code is inserted into the appropriate directory structure from above. The prompt for generating source code asks the LLM to do the following:
1. Understand the recommended technology and standards.
2. Understand the feature to be implemented.
3. Identify which source code files need to be created and/or modified.
4. Make the appropriate modifications to those source code files.

Steps 504 and 506 continue in a loop until sample source code has been generated for every feature in the list of features generated as the output of FIG. 4.

The evaluation module 107 provides an independent assessment of the PRD's completeness and accuracy. It generates a quantitative score based on factors like alignment with input requirements and coherence using a LLM-as-a-Judge (LaaJ) approach.

This module uses the application description and application context as its inputs. It evaluates the outputs generated by the decomposition module 105 via an adversarial prompt that determines whether any scope was missed by the decomposition module. If some scope is missed, this information is sent to the decomposition module to generate additional outputs.

For the Culinary Canvas example, the evaluation module checks if all specified features—like “recipe sharing,” “rating,” and “comments”—are included in the PRD. If a feature is missing or inaccurately represented, the module adjusts the score, prompting further refinement as needed.

The output generation module 106 compiles and formats the final PRD or other generated artifacts, ensuring they are ready for review and use. Upon completion, the output generation module assembles the PRD for Culinary Canvas, organizing it into sections like “User Stories,” “Acceptance Criteria,” and “Feature Descriptions” for a structured output.

The LLM Interface Module 110 manages all interactions with one or more large language models, enabling the PRD-AI system to remain adaptable and LLM-agnostic. It uses metadata for each LLM to determine the best LLM for each task, and routes requests accordingly. The LLM interface module also manages rate limits and routes requests to the LLM instance with the most available capacity. For the Culinary Canvas example, the LLM Interface Module coordinates with the LLM to interpret prompts, decompose tasks, and return PRD components, regardless of the LLM type used.

The parallel processing module 108 optimizes the system's performance by handling multiple LLM requests simultaneously, which is particularly useful for complex or large PRDs. It manages parallel feature threads, each associated with a top-level epic or feature, to generate all individual features efficiently. The module performs the following steps:
Determines the optimal batch size based on system resources and LLM capabilities
Groups requests into batches
Sends batches to the LLM Interface Module for processing
Collects and orders responses

In the Culinary Canvas application, parallel processing enables the system to handle tasks like generating user stories, acceptance criteria, and feature specifications concurrently, enhancing efficiency for a feature-rich platform. For instance, suppose there is a top-level epic titled “User Registration” with features such as “Sign up with Google,” “Sign up with Email,” “Sign up with LinkedIn,” and “Sign up with Facebook.” During the parallel process, each feature is executed on an independent thread and instance of an LLM model.

In this setup, if we create an independent thread for the feature “Sign up with Google,” the prompt would also include information about the surrounding features-ensuring that each task is contextually aware of other features and epics within the broader application. This context-aware parallel processing allows for more cohesive feature generation across the project.

The module matching module 109 leverages a RAG architecture to index and match pre-existing code to features generated within a PRD. Based on the description of the feature, we match it to the search description of an existing piece of code (“module”). After matching we create a match score which is based on the similarity score of the feature description and search description. We then show the top 3 matched modules to the user.

In the Culinary Canvas application, the module matching module uses a RAG (Retrieval-Augmented Generation) architecture to index and match pre-existing code modules to newly generated features within a PRD. Suppose Culinary Canvas has a feature for “Recipe Rating” within an epic related to user engagement. The Module-Matching Module takes the description of this “Recipe Rating” feature and searches for existing modules that could fulfill similar functionality.

For instance, if a module titled “User Rating System” already exists, the module matching module will assess the similarity between this module's search description and the “Recipe Rating” feature description. The module calculates a match score based on this similarity, then presents the top three matched modules to the user, such as:
1. User Rating System (85% match)—Provides a scalable system for users to rate items.
2. Recipe Feedback Module (75% match)—Allows users to leave ratings and comments on recipes.
3. Content Rating Feature (70% match)—Enables rating of content types across the platform.

This matching system helps developers quickly identify reusable code, speeding up development and ensuring consistency across similar features within Culinary Canvas.

The PRD-AI system employs several advanced algorithms to enhance its ability to generate accurate, structured PRDs from natural language input. Key algorithms include a prompt engineering algorithm that tailors LLM prompts to optimize PRD generation based on user input. Techniques such as dynamic prompt generation and few-shot learning ensure the LLM understands context and expected outputs.

### Steps:

Generate contextual prompts based on input.
Incorporate domain-specific terminology and best practices.
Use iterative prompts to refine output until accuracy thresholds are met.

A parallel LLM request management algorithm optimizes system efficiency by handling multiple LLM requests simultaneously, reducing processing time for complex requirements. Each top-level feature in a PRD is assigned as an independent job with its own instance of the LLM. For each job, a unique prompt includes details such as the app name, app description, top-level epics, features, user roles, and any custom fields specified by the user. This setup ensures that each parallelized job is contextually aware of the overall project and other related features.

The request management mechanism includes a throttling safeguard that operates as a FIFO queue, maintaining system stability at peak times. This mechanism monitors platform-wide LLM token usage across all concurrent PRD creations, balancing resource allocation.

### Steps:

1. Queue LLM requests based on system resources.
2. Check the token throttle limit for the entire platform.
   If the throttle limit is reached: Place the request in a wait queue.
   If the throttle limit is not reached: Submit the request to the LLM.
3. Process each request by generating an expanded feature definition that includes:
   Feature name
   Feature category
   User roles
   Description
   Acceptance criteria
   Any additional custom fields specified by the user
4. Receive the response and forward it to the Output Module.

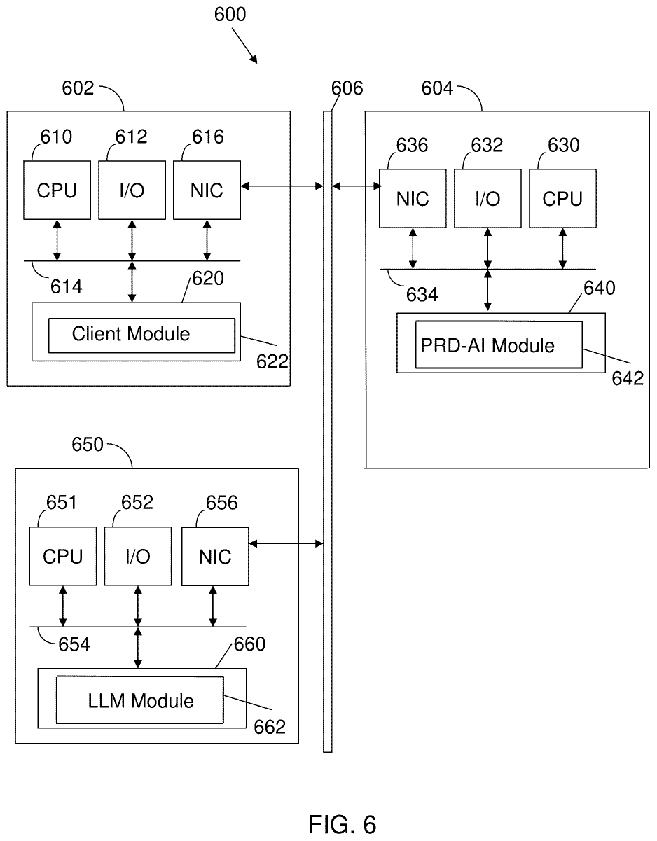

FIG. 6 illustrates a system 600 configured in accordance with an embodiment of the invention. The system 600 includes a client machine 602 in communication with a server 604 via a network 606, which may be any combination of wired and wireless networks. The client machine 602 includes a processor 610 and input/output devices 612 connected via a bus 614. A network interface circuit 616 is connected to bus 614 and provides connectivity to network 606. A memory 620 is also connected to the bus 614. The memory stores a client module 622 with instructions executed by processor 610 to implement operations disclosed herein. The client module 622 communicates with server 604 to provide server 604 with natural language descriptions for a PRD.

The server 604 includes a processor 630, input/output devices 632, a bus 634 and a network interface circuit 636 to provide connectivity to network 606. A memory 640 is connected to bus 634. The memory 640 stores a PRD-AI module 642 with instructions executed by processor 630 to implement operations disclosed herein.

An LLM machine 650 is also connected to network 606. The LLM machine 650 includes a processor 651, input/output devices 652, a bus 654 and a network interface circuit 656 to provide connectivity to network 606. A memory 660 is connected to bus 654. The memory stores an LLM module 662 with instructions executed by processor 651 to host an LLM. The PRD-AI module 642 interacts with the LLM module 662 to implement operations disclosed herein to generate a PRD that can be passed to the client machine 602.

Those skilled in the art will recognize various key features associated with the disclosed technology.
Modularity: The system's modular design supports easy integration with various large language models (LLMs), making it adaptable to different AI technologies.
Multi-purpose Artifact Generation: The system can generate various software development artifacts, including, but not limited to, product requirements documents (PRDs), software project quotes, project plans and timelines, scope documents, user personas, user stories, and acceptance criteria.
LLM-Agnostic: PRD-AI can function with any LLM, ensuring flexibility and future-proofing the system as new LLMs are developed.
Progressive Decomposition: This method systematically breaks down requirements into smaller, actionable tasks, facilitating detailed and precise software development planning.
Independent Evaluation: The system uses an independent Generative AI-based evaluator to assess the PRD output and provide a quantitative score on the completeness and accuracy of the PRD.
Parallel Processing: By handling multiple LLM requests simultaneously, the system reduces load times and enhances performance, particularly for large or complex PRDs.
AI-Ready Task Generation: Leveraging Progressive Decomposition, PRD-AI breaks down requirements into “Tasks” that are suitable for high-accuracy AI code generation tools.

Those skilled in the art will appreciate that the disclosed technology can be applied in various scenarios within the software development industry, including, but not limited to:
Rapid Prototyping and Concept Development: PRD-AI can quickly generate initial product requirements from natural language descriptions, helping teams prototype concepts faster and test feasibility early in development.
Streamlining the Requirements-Gathering Process: By automating the transformation of natural language input into structured requirements, PRD-AI reduces the time and effort needed to gather and document requirements, ensuring teams have a solid foundation for development.
Standardizing Documentation Across Large Organizations: PRD-AI can produce consistent documentation across multiple teams, enforcing uniformity in requirements structure and terminology, which is especially valuable in large organizations managing complex projects.
Facilitating Communication Between Business and Technical Teams: PRD-AI generates documents that are easy for both technical and non-technical stakeholders to understand, improving collaboration and reducing misunderstandings.
Accelerating Estimation and Quoting for Software Projects: By breaking down requirements into tasks and acceptance criteria, PRD-AI enables project managers to estimate time and resources with greater accuracy, supporting quicker and more reliable project quotes.
Assisting in the Creation of Comprehensive Test Plans and Scenarios: PRD-AI's structured output can provide the basis for developing detailed test plans, ensuring that all features and requirements are covered in testing phases, and improving overall quality assurance.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media, optical media, magneto-optical media, and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising
a network interface circuit with connectivity to a network interconnecting a client machine and a large language model machine,
a processor,
a bus connecting the network interface circuit and the processor,
a memory connected to the bus, the memory storing instructions executed by the processor to:
receive a natural language product requirements description from the client machine,
generate an exemplary list of features for the natural language product requirements description,
produce a specification of expected output,
pass the natural language product requirements description, the exemplary list of features and the expected output to the large language model machine,
evaluate a response from the large language model machine for product requirements completeness and accuracy.

2. The machine of claim 1 wherein the response is decomposed into individual tasks that are reapplied to the large language model machine.

3. The machine of claim 2 wherein the individual tasks are applied in parallel to large language model machines.

4. The machine of claim 1 wherein the exemplary list of features specifies onboarding requirements.

5. The machine of claim 1 wherein the exemplary list of features specifies user management requirements.

6. The machine of claim 1 wherein the exemplary list of features specifies task management requirements.

7. The machine of claim 1 wherein the exemplary list of features specifies project planning requirements.

8. The machine of claim 1 wherein the exemplary list of features specifies communication and collaboration requirements.

9. The machine of claim 1 wherein the exemplary list of features specifies document management requirements.

10. The machine of claim 1 wherein the exemplary list of features specifies security requirements.

11. The machine of claim 1 wherein the exemplary list of features specifies compliance requirements.

12. The machine of claim 1 wherein the expected output defines expected computer code.
